(19) United States
(12) Patent Application Publication
(10) Pub. No.: US 2019/0045723 A1
(43) Pub. Date: Feb. 14, 2019

(54) SIZE-ADJUSTABLE RECEPTACLE

(71) Applicant: Edward KANDEL, McHenry, IL (US)

(72) Inventor: Edward KANDEL, McHenry, IL (US)

(21) Appl. No.: 16/165,483

(22) Filed: Oct. 19, 2018

Related U.S. Application Data
(63) Continuation of application No. 14/297,931, filed on Jun. 6, 2014.

(51) Int. Cl. A01G 9/02; B65D 21/08; A01K 31/04; A01K 1/035; A01K 1/03; A01K 63/00; A01K 1/015; A47G 23/06

(52) U.S. Cl. CPC A01G 9/028; B65D 21/086; A01K 31/04; A01K 1/035; A01K 1/03; A01G 9/02; A01K 63/006; A01K 1/0157; A47G 23/06

(57) ABSTRACT

An apparatus and parts for forming a size-adjustable receptacle are disclosed. In some embodiments, a part of a receptacle is provided, the receptacle being assembled from a plurality of parts. The part of the receptacle includes a surface having formed therein a plurality of protrusions suitable to mate in interlockable cooperation with protrusions of at least a second part of the receptacle, such that a choice of which protrusions of the first part to mate with protrusions of the second and third parts, determines a size of the receptacle.

### PRIORITY

This application is a continuation in part of U.S. patent application Ser. No. 14/297,931, filed on Jun. 6, 2014, entitled “SIZE-ADJUSTABLE RECEPTACLE,” which is incorporated herein in its entirety.

### TECHNICAL FIELD

The present disclosure relates to a size-adjustable receptacle.

### BACKGROUND

There are many uses of receptacles of a fixed size. For example: a tray that slides under a pet cage; a tray used to hold plants; a food tray to hold food; a cargo liner for a truck; a floor mat; a receptacle to line a tool box or hold gravel in a fish tank.

### SUMMARY

The present disclosure advantageously provides a size-adjustable receptacle and parts therefor. According to one aspect, a size-adjustable receptacle includes a first part having a generally flat surface in which is formed a first two dimensional array of surface interlockable protrusions of small size in comparison to a size of the first part, the first part also having a first plurality of wall interlockable protrusions at an edge of the first part, the first plurality of wall interlockable protrusions being oriented at a first angle with respect to a plane of the generally flat surface of the first part; and a second part having a generally flat surface in which is formed a second two dimensional array of surface interlockable protrusions of small size in comparison to a sized of the second part, the second part also having a second plurality of wall interlockable protrusions at an edge of the second part, the second plurality of wall interlockable protrusions being oriented at the first angle with respect to a plane of the generally flat surface of the second part. The first and second parts are alignable such that a selectable portion of the first two dimensional array of surface interlockable protrusions mate with a portion of the second two dimensional array of surface interlockable protrusions and such that first ones of the first plurality of wall interlockable protrusions mate with second ones of the second plurality of wall interlockable protrusions, the selecting being performed to adjust a size of the size-adjustable receptacle and such that the planes of the generally flat surfaces of the first and second parts are parallel and nearly coincident, the planes being separated only by a thickness of one of the first and second parts.

According to this aspect, in some embodiments, the plurality of wall interlockable protrusions of the first and second parts are formed in walls extending upward at a second angle with respect to the generally flat surfaces of the first and second parts. In some embodiments, the first angle is about the same as the second angle. In some embodiments, the walls extending upward at the second angle enable construction of a receptacle having depth. In some embodiments, the wall interlockable protrusions extend outward from the walls in a direction about perpendicular to a direction of protrusion of the surface interlockable protrusions. In some embodiments, the first part and the second part are complementary, such that when mated, the first and second part exhibit symmetry about an axis lying in one of the two planes of the first and second parts. In some embodiments, the first and second parts have corners and two walls that are perpendicular and joined by the corners. In some embodiments, at least one of the first and second parts exhibit a corner. In some embodiments, one of the two parts exhibits a corner of the size-adjustable receptacle and the other of the two parts is a center part that does not form a corner of the size-adjustable receptacle. In some embodiments, the first and second parts have at least nearly identical thicknesses. In some embodiments, the size-adjustable receptacle further includes at least two additional parts having surface interlockable nodes and wherein four parts each exhibit corners, so that when the four parts are assembled by mating surface and wall interlockable nodes, respectively, the size-adjustable receptacle is one of a tray and a vessel having four corners. In some embodiments, a width and a length of the size-adjustable receptacle are both at least partially determinable by an amount of overlap of at least four parts when assembled.

According to another aspect, a collection of parts that, when assembled, form a receptacle is provided. The collection of parts includes: a first part having a first three dimensional array of interlockable nodes, the first three dimensional array having a first row of interlockable nodes formed along a wall of the first part and having a first plurality of rows of interlockable nodes formed in a surface of the first part, the surface of the first part being one of perpendicular to the wall of the first part and at an angle with respect to the wall of the first part; and a second part having a second three dimensional array of interlockable nodes, the second three dimensional array having a second row of interlockable nodes formed along a wall of the second part and having a second plurality of rows of interlockable nodes formed in a surface of the second part, the surface of the second part being one of perpendicular to the wall of the second part and at an angle with respect to the wall of the second part; and the first part and the second part being able to be assembled such that interlockable nodes on the surfaces mate and interlockable nodes on the walls mate.

According to this aspect, in some embodiments, the first part and the second part are complementary, such that when mated, the first and second part exhibit symmetry about an axis lying in one of the two planes of the first and second parts. In some embodiments, the collection of parts further includes at least two additional parts having surface interlockable nodes and wherein four parts each exhibit corners, so that when the four parts are assembled by mating surface and wall interlockable nodes, respectively, the size-adjustable receptacle is one of a tray and a vessel having four corners. In some embodiments, the wall of the first part and the wall of the second part each have corresponding multiple rows of interlockable nodes.

### BRIEF DESCRIPTION OF THE DRAWINGS

FIG. 1 is an assembled size-adjustable receptacle constructed in accordance with methods and parts described herein;

FIG. 2 is a corner part of a size-adjustable receptacle with interlockable nodes;

FIG. 3 is a cut-away view of two parts overlapping and interlocked by mating interlockable nodes;

FIG. 4 is an edge view of an outer edge of an interlockable part;

FIG. 5 is an illustration of two interlockable part positioned to overlap by mating interlockable nodes;

FIG. 6 is an edge view of a part that has a divider formed therein for creating a receptacle with separated regions;

FIG. 7 is a corner part of a size-adjustable receptacle having perforated holes;

FIG. 8 is a corner part of a size-adjustable receptacle having rectangular slots;

FIG. 9 is a corner part showing how channels that extend partially up a side of the size-adjustable receptacle increase rigidity of the size-adjustable receptacle;

FIG. 10 is a portion of a size-adjustable receptacle;

FIG. 11 is a side wall of a size-adjustable receptacle showing notches for receiving protrusions to form interlockable parts;

FIG. 12 shows a vertical wall having notches that receive protrusions of a bottom portion of the size-adjustable receptacle;

FIG. 13 is a view of three parts A, B and C overlapping to form a size-adjustable receptacle with a vertical wall having interlockable protrusions on the vertical walls;

FIG. 14 is a cutaway view of a size-adjustable receptacle with a vertical wall having interlockable protrusions on the vertical wall;

FIG. 15 is a cutaway view of a size-adjustable receptacle having vertical protrusions but otherwise no vertical wall; and

FIG. 16 is a top view of two parts that can overlap to form a size-adjustable receptacle with vertical walls.

### DETAILED DESCRIPTION

Before describing in detail exemplary embodiments that are in accordance with the present invention, it is noted that the embodiments reside primarily in combinations of apparatus components and processing steps related to size-adjustable receptacles. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

As used herein, the term “receptacle” includes a tray, a vessel, a pan, a liner, a mat, a basin, a holder, a container, or object configurable to hold or support a substance. As used herein, the term “interlockable nodes” or interlockable entities or interlockable protrusions include protuberances, mating entities, fittings, parts or objects shaped to mate with complementary-shaped objects. To “interlock” means to removably or irremovably affix or mate two interlockable entities. In some embodiments, to interlock may call for the application of slight force to snap the two complementary shaped features together. In removably-affixable embodiments, slight force may be called for to separate the interlocked parts.

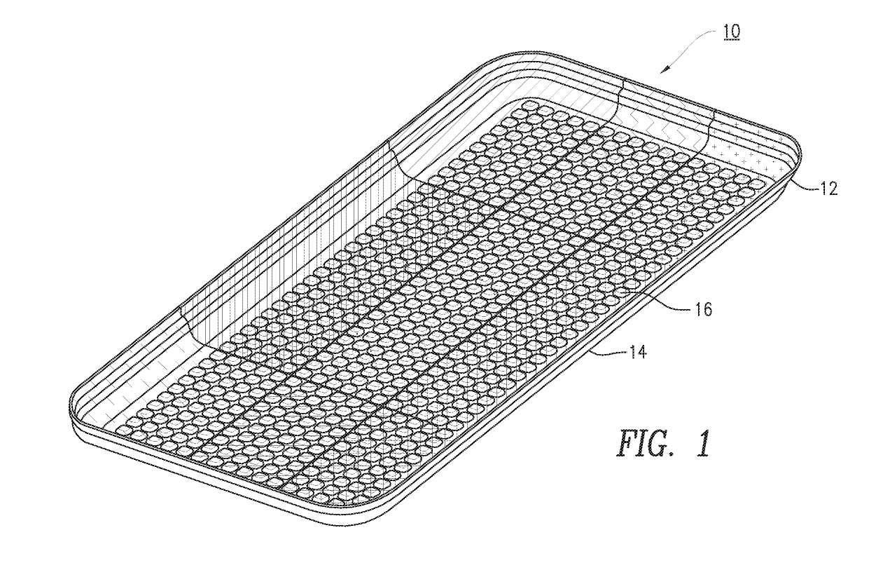

FIG. 1 shows an assembled size-adjustable receptacle 10 that consists of 9 parts: 4 corner parts 12 and 5 center parts 14. The number of parts shown in FIG. 1 is representative of one embodiment. Other embodiments may have different numbers of parts, such as, for example, four corner parts. In some embodiments, each part contains at least one row of interlockable entities 16. The interlockable entities 16 of one part are interlocked with interlockable entities 16 of an adjacent part. By adjusting the extent of overlap of adjacent parts, the size of the receptacle 10 can be adjusted in length and/or width. The receptacle 10 can be assembled by interlockable the overlapping interlockable entities of adjacent parts by pressing firmly to snap the parts together Note further, that by adding center pieces such as center parts 14, the receptacle can be made of any desired size, and could even, for example, cover an entire floor of a large room. For example, the receptacle could be used to hold concrete forming a floor of a room or building.

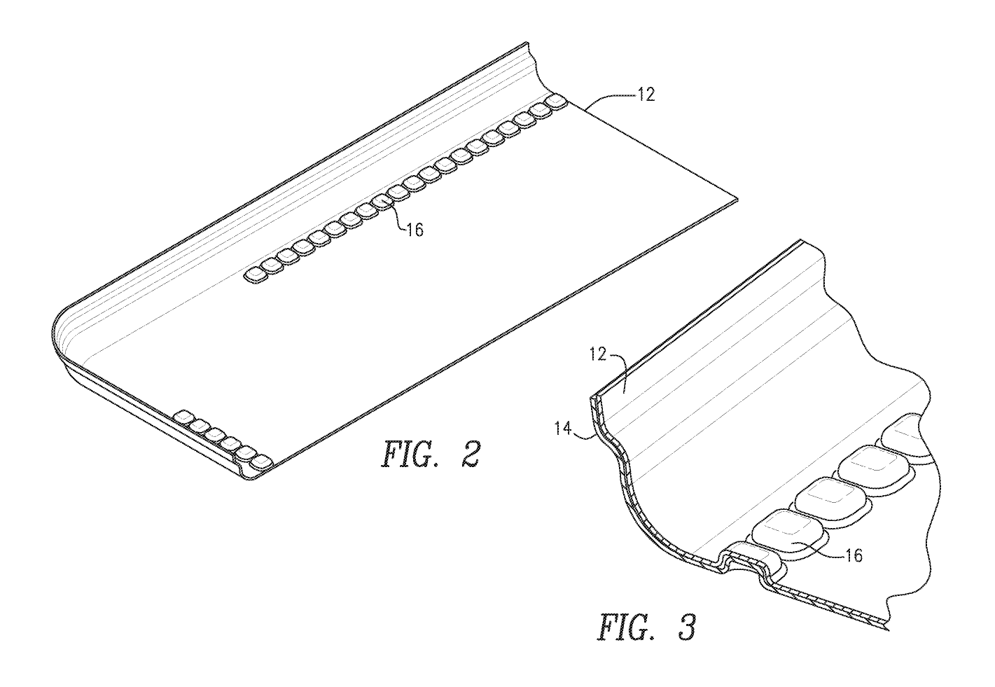

FIG. 2 shows a corner part 12 with interlockable nodes 16. Although only one row of interlockable nodes 16 is shown on each edge in orthogonal directions, in some embodiments, more rows in one or both directions may be included.

FIG. 3 shows a cut-away view of two parts 12 and 14 overlapping and interlocked by mating interlockable nodes 16. Note that although the drawing figures show only square interlockable nodes, in some embodiments, other shapes of interlockable nodes, such as round interlockable nodes, can be employed. Note also, that in some embodiments, at least some of the interlockable nodes are located near an outer wall and near an edge where the two parts overlap when the size-adjustable receptacle is assembled. In some embodiments, the interlockable entities are located on the outer walls of parts to be joined.

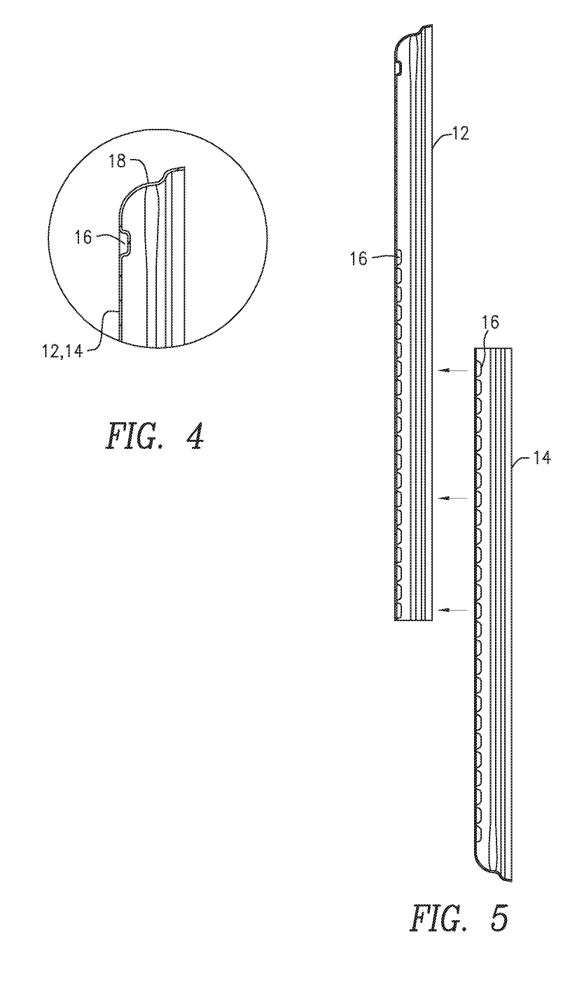

FIG. 4 shows an edge view of the outer edge of an interlockable part 12, 14 having interlockable nodes 16. In this embodiment, the interlockable part exhibits a curved wall 18 on the outer edge. The curved wall 18 gives the receptacle depth when assembled. The depth of the receptacle is determined by the height of the wall 18. Thus, a deep receptacle or a shallow receptacle can be made. For example, a shallow wall may be employed when forming a tray. In alternative embodiments, the interlockable parts have no wall 18, so that the receptacle is generally flat—except for the nodes—having no depth. In some embodiments, the wall 18 may be much higher than the height shown in the figures.

FIG. 5 shows two interlockable parts 12, 14 positioned to overlap and be assembled by mating interlockable nodes 16. The extent of overlap at least in part determines a size of the finally-assembled receptacle.

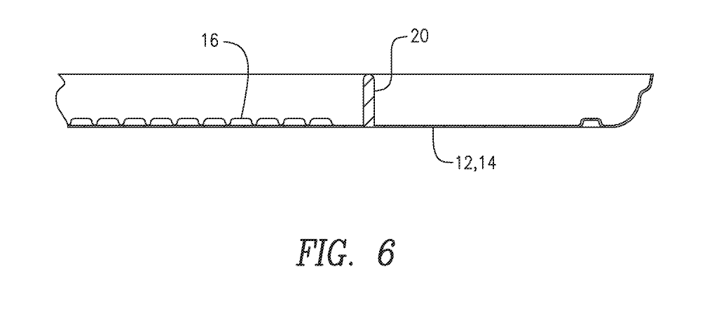

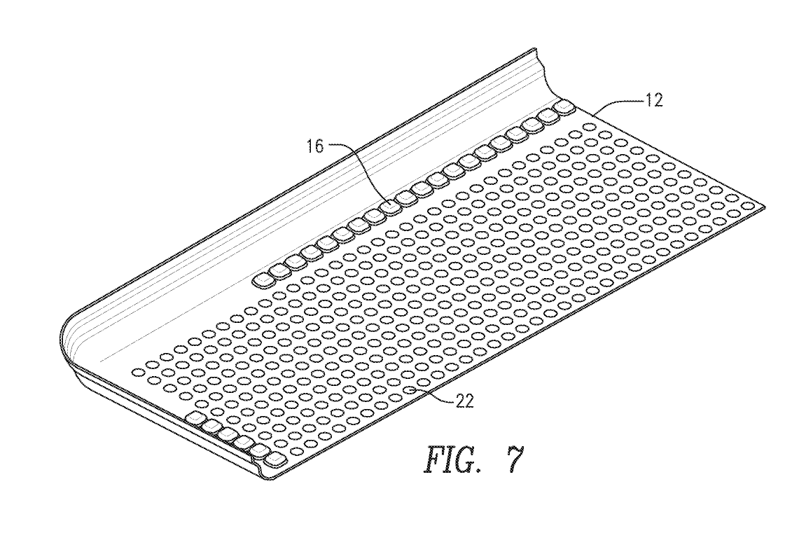

FIG. 6 is an edge view of a part 12, 14 that has a divider 20 formed therein for creating a receptacle 10 with a divider to separate the assembled receptacle into different section or regions. In some embodiments, the divider 20 is the same height as the wall 18.

FIG. 7 is a corner part of a size-adjustable receptacle having perforated holes. The perforated holes may be desired in applications, such as plant trays, where the receptacle is to hold solid matter but not liquid matter.

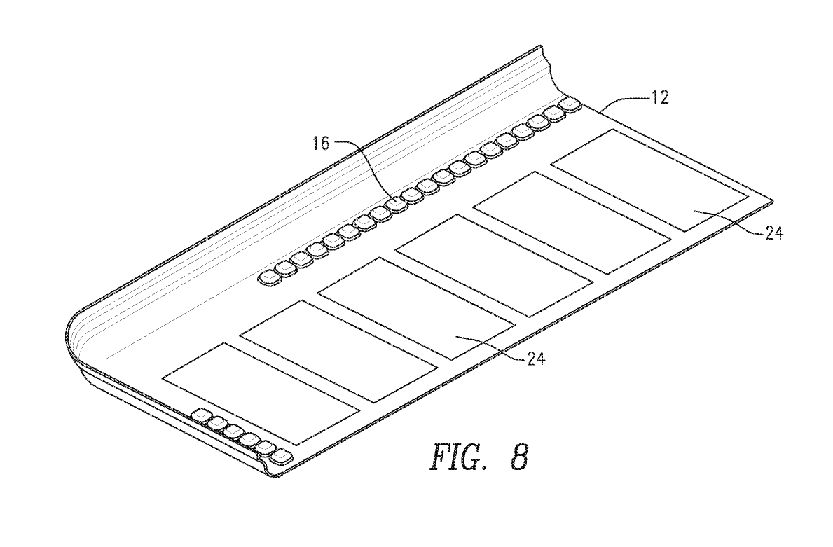

FIG. 8 is a corner part of a size-adjustable receptacle having rectangular slots. The rectangular slots may be desired in applications where the receptacle is used as a concrete reinforcement structure, for example.

As shown in the drawing figures, in some embodiments an interlockable entity is a protuberance having a size that is substantially smaller than a size of a part containing the protuberance. In some embodiments, the interlockable node may be elongated or much larger.

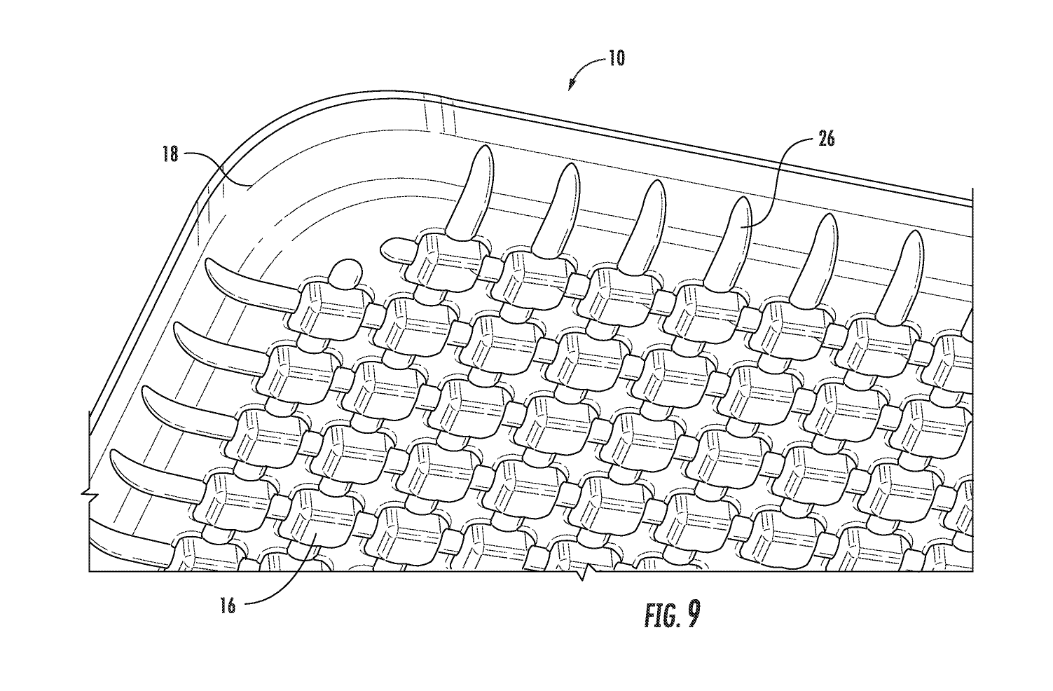

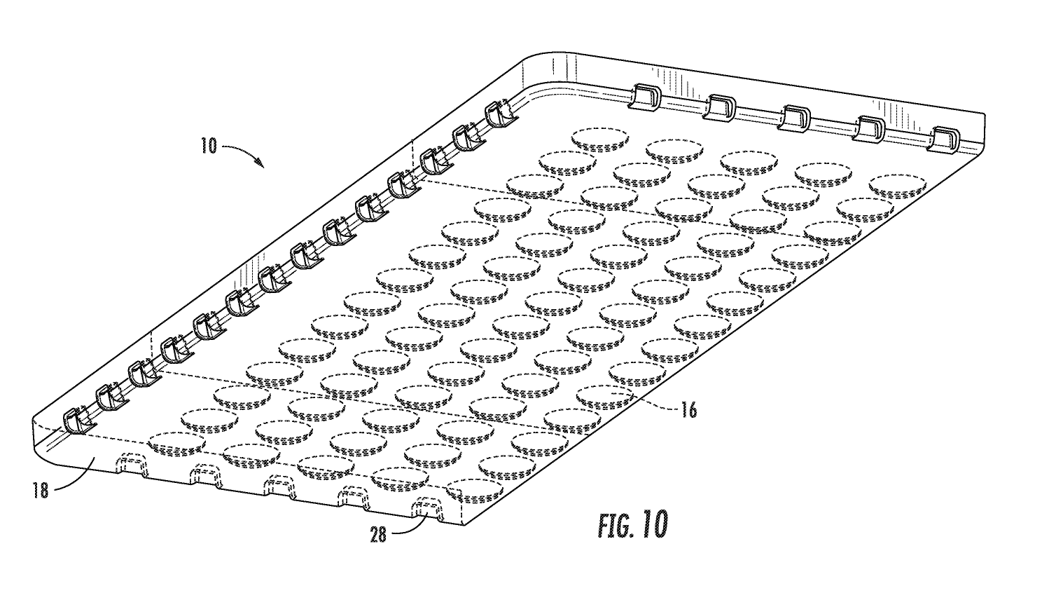

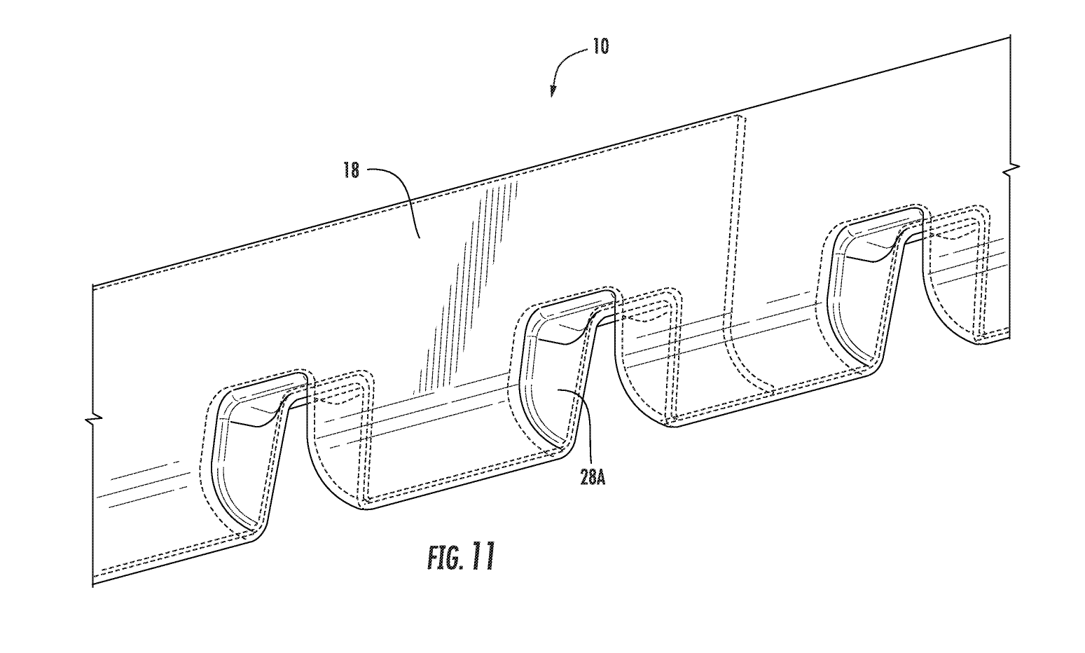

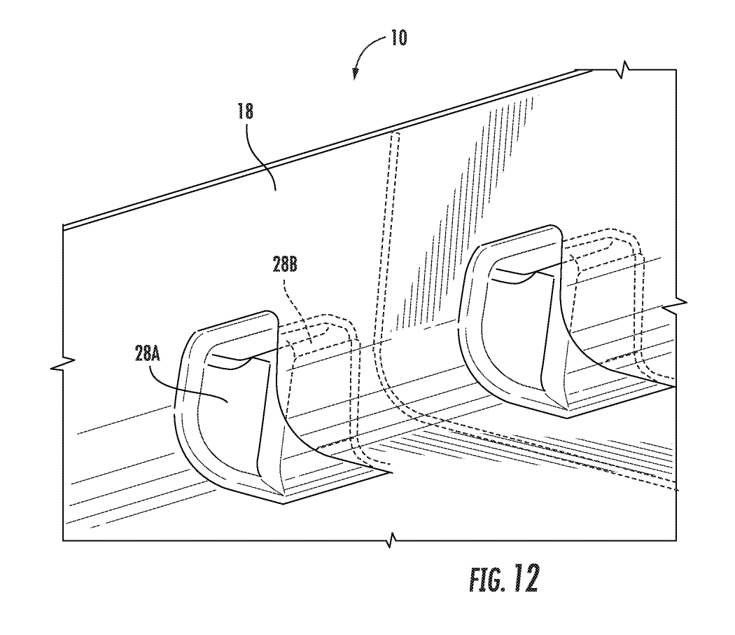

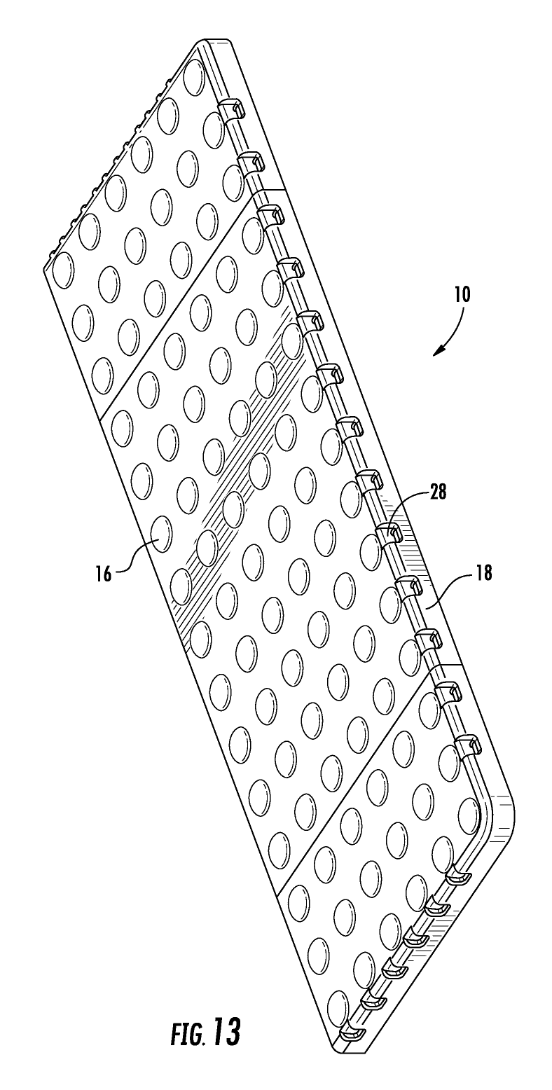

FIG. 9 is a corner part showing how channels 26 that extend partially up a side wall 18 of the size-adjustable receptacle 10 increase rigidity of the size-adjustable receptacle 10. FIG. 10 illustrates a size-adjustable receptacle 10 having interlockable parts 28 on an edge of a vertical wall 18 of the size-adjustable receptacle 10. FIG. 11 is a side wall 18 of a size-adjustable receptacle 10 showing notches 28A for receiving protrusions 28B (shown in FIG. 12) to form interlockable parts. FIG. 12 shows a vertical wall 18 having notches 28A that receive protrusions 28B of a bottom portion of the size-adjustable receptacle 10.

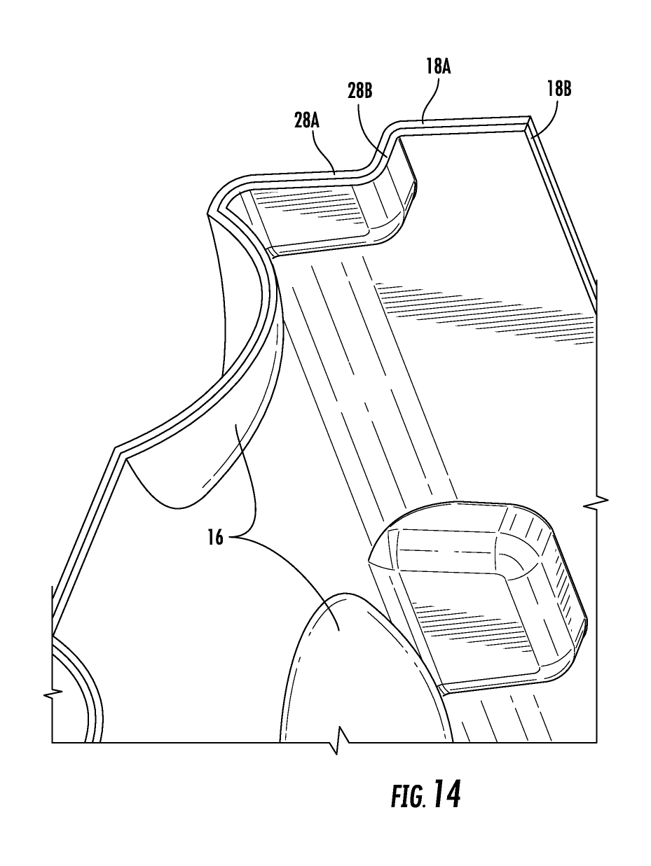

FIG. 13 is a view of three parts A, B and C overlapping to form a size-adjustable receptacle 10 with vertical walls 18 having interlockable protrusions 28 on the vertical walls 18. Interlockable protrusions 16 of part A interlock with protrusions 16 of part B, for example. Likewise, vertical interlockable protrusions 18 of part A interlock with vertical interlockable protrusions 18 of part B, for example. Note that the walls of the three parts A, B and C can be taller with additional rows of interlockable protrusions, so that a receptacle of any depth can be manufactured for assembly. Note that the walls can be vertical or at an acute or obtuse angle with respect to the surface of the parts. The parts A, B and C, or just parts A and C, can be adjustable to overlap to achieve a receptacle of any desired size, and such that the planes of the surfaces of the parts are parallel and nearly coincident, being separated only by a thickness of a part. Note further that the wall interlockable protrusions may extend outward or inward in a direction that is perpendicular to a face of the wall.

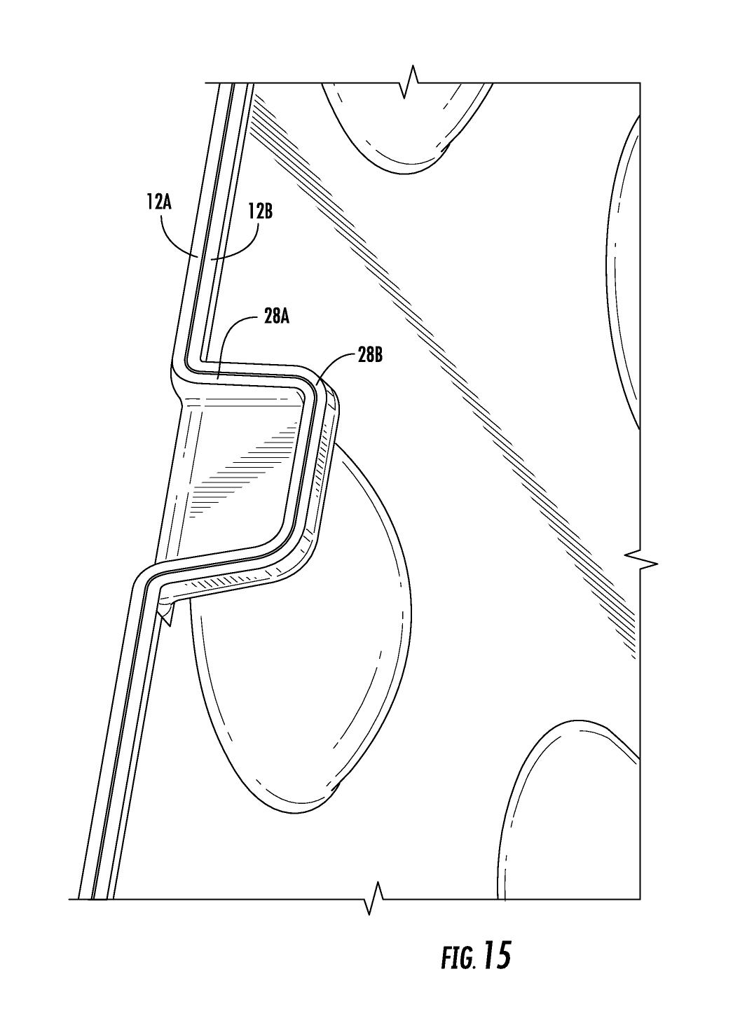

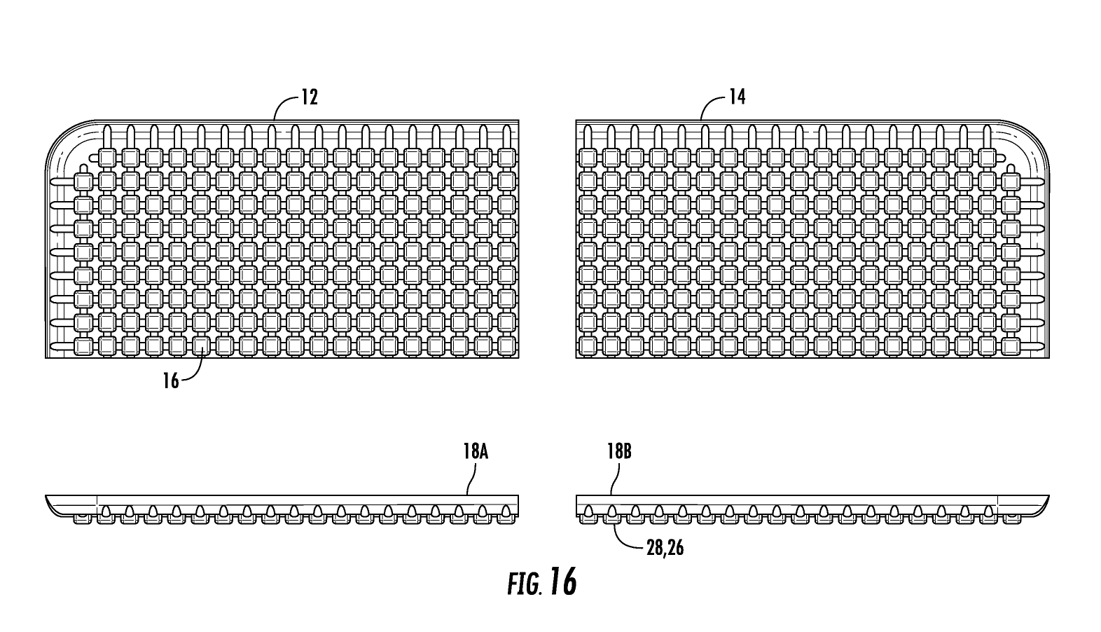

FIG. 14 is a cutaway view of a size-adjustable receptacle 10 with a vertical wall 18A having interlockable protrusions 28A on the vertical wall 18A, and a vertical wall 18B having interlockable protrusions 28B that mate with interlockable protrusions 28A of vertical wall 18A. Note that interlockable protrusions 16 are shown semispherical although rectangular shapes could also be formed. FIG. 15 is a cutaway view of a size-adjustable receptacle having vertical interlockable protrusions 28A and 28B but otherwise no vertical wall, the vertical protrusions 28A and 28B being part of overlapping trays 12A and 12B. FIG. 16 is a top view of two parts that can overlap to form a size-adjustable receptacle with vertical walls. Note that the two parts in FIG. 16 are complementary, such that when mated, the assembled parts form a part that exhibits symmetry about an axis lying in a plane of one of the first and second parts. In FIG. 16, the parts have corners and walls that are perpendicular and joined by the corners.

Thus, in some embodiments, each part of some of the parts forming a size-adjustable receptacle exhibit a three dimensional array of interlockable nodes, having at least one row of interlockable nodes formed along a wall of a part and having a plurality of rows of nodes formed in a surface of the part.

The size-adjustable receptacle may be used as one of a plant tray, a food tray, a liquid vessel, a drawer liner, a cargo liner, a floor mat, a receptacle that slides under an object, a tool box liner, a gravel holder for one of a fish tank and a reptile tank, a pet cage liner, a liner for an animal pen, a sand box, for spill containment and a shelf liner. In some embodiments, at least one part of the size-adjustable receptacle is one of rigid and flexible, one of biodegradable, paper, cardboard, wood pulp, metal, recyclable and plastic, and one of transparent, opaque, colored, reflective and diffuse. In some embodiments, at least one part is formed by one of a thermoform process, an injection mold process, a compression mold function, a stamping process, a casting process and an extrusion process. In some embodiments, like parts of the disassembled size-adjustable receptacle stackable, one part fitting at least partially inside another.

According to one aspect, a size-adjustable receptacle is provided. The size-adjustable receptacle includes a first part having a generally flat surface in which is formed a first two dimensional array of surface interlockable protrusions of small size in comparison to a size of the first part, the first part also having a first plurality of wall interlockable protrusions at an edge of the first part, the first plurality of wall interlockable protrusions being oriented at a first angle with respect to a plane of the generally flat surface of the first part. A second part has a generally flat surface in which is formed a second two dimensional array of surface interlockable protrusions of small size in comparison to a sized of the second part, the second part also having a second plurality of wall interlockable protrusions at an edge of the second part, the second plurality of wall interlockable protrusions being oriented at the first angle with respect to a plane of the generally flat surface of the second part. The first and second parts are alignable such that a selectable portion of the first two dimensional array of surface interlockable protrusions mate with a portion of the second two dimensional array of surface interlockable protrusions and such that first ones of the first plurality of wall interlockable protrusions mate with second ones of the second plurality of wall interlockable protrusions, the selecting being performed to adjust a size of the size-adjustable receptacle and such that the planes of the generally flat surfaces of the first and second parts are parallel and nearly coincident, the planes being separated only by a thickness of one of the first and second parts.

According to this aspect, in some embodiments, the plurality of wall interlockable protrusions of the first and second parts are formed in walls extending upward at a second angle with respect to the generally flat surfaces of the first and second parts. In some embodiments, the first angle is about the same as the second angle. In some embodiments, the walls extending upward at the second angle enable construction of a receptacle having depth. In some embodiments, the wall interlockable protrusions extend outward from the walls in a direction about perpendicular to a face of the walls. In some embodiments, the first part and the second part are complementary, such that when mated, the first and second part exhibit symmetry about an axis lying in one of the two planes of the first and second parts. In some embodiments, the first and second parts have corners and two walls that are perpendicular and joined by the corners. In some embodiments, at least one of the first and second parts exhibit a corner.

In some embodiments, one of the two parts exhibits a corner of the size-adjustable receptacle and the other of the two parts is a center part that does not form a corner of the size-adjustable receptacle. In some embodiments, the first and second parts have at least nearly identical thicknesses. In some embodiments, the receptacle further includes at least two additional parts having surface interlockable nodes and wherein four parts each exhibit corners, so that when the four parts are assembled by mating surface and wall interlockable nodes, respectively, the size-adjustable receptacle is one of a tray and a vessel having four corners. In some embodiments, a width and a length of the size-adjustable receptacle are both at least partially determinable by an amount of overlap of at least four parts when assembled.

According to another aspect, a collection of parts that, when assembled, form a receptacle, is provided. The collection includes a first part having a first three dimensional array of interlockable nodes, the first three dimensional array having a first row of interlockable nodes formed along a wall of the first part and having a first plurality of rows of interlockable nodes formed in a surface of the first part, the surface of the first part being one of perpendicular to the wall of the first part and at an angle with respect to the wall of the first part. The collection further includes a second part having a second three dimensional array of interlockable nodes, the second three dimensional array having a second row of interlockable nodes formed along a wall of the second part and having a second plurality of rows of interlockable nodes formed in a surface of the second part, the surface of the second part being one of perpendicular to the wall of the second part and at an angle with respect to the wall of the second part. The first part and the second part are able to be assembled such that interlockable nodes on the surfaces mate and interlockable nodes on the walls mate.

According to this aspect, in some embodiments, the first part and the second part are complementary, such that when mated, the first and second part exhibit symmetry about an axis lying in one of the two planes of the first and second parts. In some embodiments, the collection includes at least two additional parts having surface interlockable nodes and wherein four parts each exhibit corners, so that when the four parts are assembled by mating surface and wall interlockable nodes, respectively, the size-adjustable receptacle is one of a tray and a vessel having four corners. In some embodiments, the wall of the first part and the wall of the second part each have corresponding multiple rows of interlockable nodes.

Thus, one embodiment is a size-adjustable receptacle that includes a first part and a second part. The first part has a generally flat portion and edges. The first part has a first set of interlockable nodes along a first direction perpendicular to an edge and a second set of interlockable nodes along a second direction orthogonal to the first direction. The second part has a generally flat portion and has at least a third interlockable node and at least a fourth interlockable node. The third and fourth interlockable nodes are oriented to simultaneously interlock with at least one of the first set of interlockable nodes and at least one of the second set of interlockable nodes, respectively. The first and second parts are selectively overlapping to at least partially determine at least one of a length and a width of the size-adjustable receptacle.

In some embodiments, the first set and the second set of interlockable nodes merge to cover substantially the entire flat portion of the first part. In some embodiments, the first set of interlockable nodes are arranged in a first set of rows and the second set of interlockable nodes are arranged in a second set of rows. In some embodiments, the at least a first interlockable node of the second part includes at least one row of interlockable nodes. In some embodiments, at least one of the two parts forms a corner of the size-adjustable receptacle and the other of the two parts is a center part that does not form a corner of the size-adjustable receptacle.

In some embodiments, at least one of the two parts has at least one outside edge that is raised to form an outer wall of a desired height so that when assembled, the size-adjustable receptacle exhibits a desired depth. In some embodiments, the size adjustable receptacle further includes at least two additional parts having interlockable nodes and wherein four parts each exhibit corners, so that when the four parts are assembled by mating interlockable nodes, the size-adjustable receptacle is one of a tray and a vessel having four corners.

The width and the length of the size-adjustable receptacle may both be at least partially determined by an amount of overlap of at least four parts when assembled. In some embodiments, at least one of the two parts exhibits at least one divider such that the size-adjustable receptacle is partitioned into at least two separate sections when assembled. In some embodiments, the at least two parts are substantially flat except for interlockable nodes, so that the size-adjustable receptacle is a substantially flat tray without sides.

Another embodiment is a collection of parts that, when assembled, form a receptacle. The collection of parts includes a first part having a first set of protuberances along a first direction and a second set of protuberances along a second orthogonal direction. A second part has a third set of protuberances and a fourth set of protuberances. The first set and the second set are orient-able to mate and interlock with at least the third set and the fourth set, respectively. The first part and the second part are position-able such that the at least some of the protuberances overlap to determine at least one of a length and a width of the receptacle.

In some embodiments, at least one of the first and second parts has a raised edge forming a wall of the receptacle. In some embodiments, all of the parts are substantially flat except for the interlockable nodes and none of the parts has a raised edge, the collection of parts thereby forming, when assembled, a flat tray having no walls. In some embodiments, the parts include corner parts exhibiting corners of the one of the tray and the vessel. In some embodiments, the first set of interlockable nodes are located on a wall at an edge of the first part and the third set of interlockable nodes are located on a wall at an edge of the second part.

According to yet another aspect, a part of a receptacle is provided, the receptacle being assembled from a plurality of parts. The part of the receptacle includes a surface having formed therein a plurality of protrusions suitable to mate in interlockable cooperation with protrusions of a second and third part of the receptacle, such that a choice of which protrusions of the first part to mate with protrusions of the second and third parts, determines a size of the receptacle. In some embodiments, the part is configured so that like parts of disassembled receptacles are stackable, one part fitting at least partially inside another.

In some embodiments, a size-adjustable receptacle is provided. The size-adjustable receptacle includes a first part having a generally flat first portion and a first edge, the first part having a first set of rows of interlockable nodes lying in the flat first portion along a first direction parallel to the first edge, each interlockable node of the first set having a protrusion of small size in comparison to a length of the first edge so that a plurality of the first set of interlockable nodes are positioned in first rows that are parallel to the first edge, the first edge having a first set of edge interlockable nodes along the length of the first edge. The size-adjustable receptacle also includes a second part having a generally flat second portion and a second edge, the second part having a second set of rows of interlockable nodes lying in the flat second portion along a second direction parallel to the second edge, each interlockable node of the second set of interlockable nodes configured to mate with interlockable nodes of the first set of rows of interlockable nodes when the first edge is aligned with the second edge, the second edge having a second set of edge interlockable nodes along a length of the second edge and configured to mate with the first set of edge interlockable nodes, the first and second parts selectively overlapping to at least partially determine at least one of a length and a width of the size-adjustable receptacle.

In some embodiments, the first set and the second set of rows of interlockable nodes are configured to overlap over substantially all of the generally flat first portion of the first part. In some embodiments, at least one of the two parts forms a corner of the size-adjustable receptacle and the other of the two parts is a center part that does not form a corner of the size-adjustable receptacle. In some embodiments, at least one of the two parts has at least one outside edge that is raised to form an outer wall of a desired height so that when assembled, the size-adjustable receptacle exhibits a desired depth. In some embodiments, the size-adjustable receptacle has at least two additional parts having interlockable nodes and wherein four parts each exhibit corners, so that when the four parts are assembled by mating interlockable nodes, the size-adjustable receptacle is one of a tray and a vessel having four corners. In some embodiments, the width and the length of the size-adjustable receptacle are both at least partially determined by an amount of overlap of at least four parts when assembled. In some embodiments, at least one of the two parts exhibits at least one divider such that the size-adjustable receptacle is partitioned into at least two separate sections when assembled. In some embodiments, the two parts are substantially flat except for interlockable nodes, so that the size-adjustable receptacle is a substantially flat tray without sides. In some embodiments, the at least two parts can be assembled to form a size-adjustable receptacle useable as one of a plant tray, a food tray, a liquid vessel, a drawer liner, a cargo liner, a floor mat, a receptacle that slides under an object, a tool box liner, a gravel holder for one of a fish tank and a reptile tank, a pet cage liner, a liner for an animal pen, a sand box, for spill containment and a shelf liner. In some embodiments, at least one part of the size-adjustable receptacle is one of rigid and flexible, and one of biodegradable, paper, cardboard, wood pulp, metal, recyclable material, plastic, and one of transparent, opaque, colored, reflective and diffuse. In some embodiments, at least one part is formed by one of a thermoform process, an injection mold process, a compression mold function, a stamping process, a casting process and an extrusion process.

In some embodiments, a collection of parts that, when assembled, form a receptacle are provided. The collection of parts includes a first part having a first flat portion and embedded in the first flat portion a first set of at least three rows of interlockable nodes along a first direction, the first part further having an edge extending vertically from the flat first portion and having a length along the first direction, the edge having interlockable nodes along the length. The collection of parts further includes a second part having a second flat portion and embedded in the second flat portion a second set of at least three rows of interlockable nodes along a direction parallel to an edge of the second part, the at least three rows of the first and second rows configured to be aligned to overlap and mate to determine at least one of a length and a width of the receptacle, the edge of the second part having interlockable nodes that overlap and mate with interlockable nodes along the edge of the first part. .In some embodiments, the collection of parts further include corner parts exhibiting corners of the receptacle.

In some embodiments, a part of a receptacle is provided. A receptacle is assembled from a plurality of parts, one part of the receptacle comprising a surface having formed therein a plurality of interlockable nodes suitable to mate in interlockable cooperation with interlockable nodes of at least one of a second and third part of the receptacle, such that a choice of which interlockable nodes of the first part to mate with interlockable nodes of the at least one of the second and third parts, determines a width and length of the receptacle, the part of the receptacle having a wall having interlockable nodes that mate in interlockable cooperation with interlockable nodes on a wall of at least one of the at least one of the second and third part. In some embodiments, the part is configured so that like parts of disassembled receptacles are stackable, one part fitting at least partially inside another.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A size-adjustable receptacle, comprising:
a first part having a generally flat surface in which is formed a first two dimensional array of surface interlockable protrusions smaller in size than a size of the first part, the first part also having a first plurality of wall interlockable protrusions at an edge of the first part, the first plurality of wall interlockable protrusions being oriented at a first angle with respect to a plane of the generally flat surface of the first part; and
a second part having a generally flat surface in which is formed a second two dimensional array of surface interlockable protrusions smaller in size than a size of the second part, the second part also having a second plurality of wall interlockable protrusions at an edge of the second part, the second plurality of wall interlockable protrusions being oriented at the first angle with respect to a plane of the generally flat surface of the second part;
the first and second parts being alignable such that a selectable portion of the first two dimensional array of surface interlockable protrusions mate with a portion of the second two dimensional array of surface interlockable protrusions and such that first ones of the first plurality of wall interlockable protrusions mate with second ones of the second plurality of wall interlockable protrusions, the selecting being performed to adjust a size of the size-adjustable receptacle and such that the planes of the generally flat surfaces of the first and second parts are parallel and nearly coincident, the planes being separated only by a thickness of one of the first and second parts.

2. The size-adjustable receptacle of claim 1, wherein the plurality of wall interlockable protrusions of the first and second parts are formed in walls extending upward at a second angle with respect to the generally flat surfaces of the first and second parts.

3. The size-adjustable receptacle of claim 2, wherein the first angle is about the same as the second angle.

4. The size-adjustable receptacle of claim 2, wherein the walls extending upward at the second angle enable construction of a receptacle having depth.

5. The size-adjustable receptacle of claim 2, wherein the wall interlockable protrusions extend outward from the walls in a direction about perpendicular to a face of the walls.

6. The size-adjustable receptacle of claim 1, wherein the first part and the second part are complementary, such that when mated, the first and second part exhibit symmetry about an axis lying in one of the two planes of the first and second parts.

7. The size-adjustable receptacle of claim 6, wherein the first and second parts have corners and two walls that are perpendicular and joined by the corners.

8. The size adjustable receptacle of claim 1, wherein at least one of the first and second parts exhibit a corner.

9. The size-adjustable receptacle of claim 1, wherein one of the two parts exhibits a corner of the size-adjustable receptacle and the other of the two parts is a center part that does not form a corner of the size-adjustable receptacle.

10. The size adjustable receptacle of claim 1, wherein the first and second parts have at least nearly identical thicknesses.

11. The size-adjustable receptacle of claim 1, further comprising at least two additional parts having surface interlockable nodes and wherein four parts each exhibit corners, so that when the four parts are assembled by mating surface and wall interlockable nodes, respectively, the size-adjustable receptacle is one of a tray and a vessel having four corners.

12. The size-adjustable receptacle of claim 11, wherein a width and a length of the size-adjustable receptacle are both at least partially determinable by an amount of overlap of at least four parts when assembled.

13. A collection of parts that, when assembled, form a receptacle, the collection of parts comprising:
a first part having a first three dimensional array of interlockable nodes, the first three dimensional array having a first row of interlockable nodes formed along a wall of the first part and having a first plurality of rows of interlockable nodes formed in a surface of the first part, the surface of the first part being one of perpendicular to the wall of the first part and at an angle with respect to the wall of the first part; and a second part having a second three dimensional array of interlockable nodes, the second three dimensional array having a second row of interlockable nodes formed along a wall of the second part and having a second plurality of rows of interlockable nodes formed in a surface of the second part, the surface of the second part being one of perpendicular to the wall of the second part and at an angle with respect to the wall of the second part; and
the first part and the second part being able to be assembled such that interlockable nodes on the surfaces mate and interlockable nodes on the walls mate.

14. The collection of parts of claim 13, wherein the first part and the second part are complementary, such that when mated, the first and second part exhibit symmetry about an axis lying in one of the two planes of the first and second parts.

15. The collection of parts of claim 13, further comprising at least two additional parts having surface interlockable nodes and wherein four parts each exhibit corners, so that when the four parts are assembled by mating surface and wall interlockable nodes, respectively, the size-adjustable receptacle is one of a tray and a vessel having four corners.

16. The collection of parts of claim 13, wherein the wall of the first part and the wall of the second part each have corresponding multiple rows of interlockable nodes.
